(19) United States
(12) Patent Application Publication
(10) Pub. No.: US 2020/0055144 A1
(43) Pub. Date: Feb. 20, 2020

(54) DEVICE AND METHOD FOR ADDITIVE MANUFACTURING OF COMPONENTS WITH A PLURALITY OF SPATIALLY SEPARATED BEAM GUIDES

(71) Applicant: FRAUNHOFER-GESELLSCHAFT ZUR FOERDERUNG DER ANGEWANDTEN FORSCHUNG E.V., Muenchen (DE)

(72) Inventors: REINHART POPRAWE, Aachen (DE); FLORIAN EIBL, Aachen (DE); WILHELM MEINERS, Aachen (DE); LUCAS JAUER, Herzogenrath (DE)

(21) Appl. No.: 16/346,207

(22) PCT Filed: Nov. 9, 2017
(86) PCT No.: PCT/EP2017/078739

§ 371 Date: Apr. 30, 2019

(30) Foreign Application Priority Data
Nov. 10, 2016 (DE) 10 2016 222 068.3

(51) Int. Cl. B23K 26/342; B33Y 10/00; B33Y 30/00; B33Y 50/02; B22F 3/105; B23K 26/06; B23K 26/064; B23K 26/08

(52) U.S. Cl. CPC B23K 26/342; B33Y 10/00; B33Y 30/00; B33Y 50/02; B22F 2003/1057; B23K 26/0608; B23K 26/064; B23K 26/0876; B22F 3/1055

(57) ABSTRACT

The present invention relates to a device and a method for additive manufacturing of components, in particular selective laser melting or laser sintering. The device comprises a processing head (7) with a plurality of spatially separated beam guides, via which one or more laser beams can be directed onto a processing plane (8) along spatially separated beam paths, and one or more optical switching devices (4) with which the beam path of the respective laser beam can be switched between the spatially separated beam paths. The device enables use of a laser beam source (1) for different beam paths or target positions with a processing head (7) of such kind, whereby it is possible to achieve better utilization of the beam sources used and irradiation of the processing plane (8) corresponding to a component geometry to be created with a smaller number of laser beam sources (1).

### TECHNICAL FIELD

The present invention relates to a device for the additive manufacturing of components, in particular selective laser melting or laser sintering, which comprises a processing head with a plurality of spatially separated beam guides, via which one or more laser beams can be directed onto a processing plane along spatially separated beam paths. The invention also relates to a corresponding method for additive manufacturing of components in which the suggested device may be used.

In powder-bed based beam fusion methods such as Selective Laser Melting (SLM), three-dimensional components are prepared additively directly from 3D CAD models. In an iterative process, a thin layer of powder, typically less than 100 μm thick, is applied to a substrate plate with a spreading mechanism, and in a subsequent step is melted selectively according to the geometry information contained in the 3D CAD model with the aid of one or more energy beams. This cyclical process enables the production of three-dimensional components with few limitations in terms of structural complexity. In SLM, the compaction of the component depends on complete melting of the powder and the preceding layer. In this way, it is possible to achieve component densities of up to 100% and mechanical properties comparable with conventional manufacturing methods.

In such a method, the process chain is carried out sequentially relative to a construction platform within the production plant, as is shown diagrammatically in FIG. 1. The value-adding irradiation process, in which the corresponding areas of the layer are melted selectively with the energy beam, is interrupted by non-value adding processes which as layer application, process preparation and follow-up processing. Depending on the plant equipment used, if galvanometer scanners are used to steer the beam, for example, the value-adding irradiation process is further interrupted by technically unavoidable irradiation dead times, during which the scanner mirrors needed to deflect the beam are moved, but no irradiation takes place. This is the case for example when scan vectors which are to be irradiated one after the other are not geometrically directly adjacent to each other. Other non-productive times also occur during the acceleration and deceleration phases of the scanner mirrors. The beam source is thus not used to its full capacity for irradiation.

### RELATED ART

Alternative irradiation concepts are also known besides the beam deflection systems based on galvanometer scanners with upstream or downstream focusing optics used predominantly in the past. These are mostly less complex optics systems, which are guided over the surface to be irradiated by means of a movement device. This offers the advantage of enabling possible scaling of the dimensions of the installation space and/or the melting power without having the change the basic equipment structure.

Thus for example WO 2015/003804 A1 discloses a device in which an irradiation or processing head is moved over a powder bed with the aid of an axis system. The processing head uses an optical device to project a plurality of laser beams in a fixed position assembly side by side as laser spots or partially overlapping onto the processing plane, e.g., in a linear assembly perpendicularly to the direction of movement of the processing head. In this context, the laser beams are each generated by a separate beam source, guided to the processing head via optical fibres, and modulated or switched on and off depending on the component geometry to be created simultaneously with the movement of the processing head. Document WO 2014/199149 A1 discloses a similar device, in which the respective beam sources direct the radiation directly onto the processing plane without any optical fibres. However, these devices need a separate beam source for each individual laser spot in the processing plane. This does mean that the spot arrangement can be widened practically without limit by increasing the number of beam sources. But it is also associated with a linear increase in costs. Moreover, the cost of construction is increased correspondingly.

US 2014/0198365 A1 describes an irradiation device in which the radiation from a single beam source is split into a plurality of partial beams by means of one or more beam splitters. The partial beams are then each directed separately and independently onto the processing plane by their own deflection units. With this arrangement, however, given the constant splitting of the laser power among the individual partial beams, arrangements must be made to ensure that the area to be irradiated by the respective beam deflection devices is identical.

Document WO 00/21735 A1 suggests an irradiation device in which the emission from one light source is directed at the processing plane via a plurality of individual optical fibres which are arranged in a fixed position array. A light valve is attached behind each fibre end and is able to either transmit or absorb the radiation emerging from fibre depending on a control signal. In this way, areas belonging to the component can be irradiated selectively in the processing plane by the movement of the fibre array and the controller which is dependent on the component geometry of the light valves. During operation of this device, the radiation of certain irradiated areas, which are not needed for constructing the component must be absorbed in the associated light valves. In practical use, however, this leads to a low ratio between the laser power generated and the laser power actually used. This also applied for some of the devices described earlier.

The disadvantages of the known devices described above make it more difficult to use powder bed based laser beam melting methods economically, in serial production of metal components for example.

The object of the present invention is to describe a device and a method for additive manufacturing of components by layered melting of a particulate material with laser radiation, which enables improved exploitation of the beam sources employed without thereby being limited to certain areas to be irradiated.

### SUMMARY OF THE INVENTION

The object is solved with the device and the method according to claims 1 and 10. Advantageous variants of the device and of the method are the subject matter of the dependent claims or may be understood from the following description and exemplary embodiments.

The suggested device has a processing head with a plurality of spatially separated beam guides having corresponding beam guide and/or beam deflection elements, by means of which one or more laser beams may be directed onto a processing plane along spatially separated beam paths, a laser beam source assembly, with which the one or more laser beam(s) may be generated, and a device for supplying a material in the processing plane. The device further comprises a moving device, with which a relative movement may be effected between the processing head and the processing plane, preferably in planes parallel to one another, and a control device, with which the moving device may be activated to effect said relative movement. The device is characterized in particularly by the fact that one or more optical switching devices are present, with which the beam path of the one or more laser beams may be switched between the spatially separated beam paths. The optical switching devices are preferably embodied as beam switches. These may have the form of optoelectronic elements, for example, or of one or more tiltable mirror elements.

This variant of the suggested device enables the possibility of better utilization of the beam source used to generate the respective laser beam. Thus for example, with a powder-bed based beam fusion method the laser beam may be switched from a first beam path to a second beam path if it is no longer needed for irradiation at the target position of the first beam path at least temporarily, while irradiation is still needed at a target position of the second beam path. Whereas previously two laser beam sources were needed for such a situation, and each had to be switched off temporarily, with the suggested device it is possible to achieve the same effect using only one laser beam source, which is utilized more efficiently in terms of time due to the switching capability. Of course, the number of spatially separated beam paths per laser beam is not limited to two.

A further option for operating the laser beam source with as little interruption as possible consists in operating the laser beam source in pulsed mode and executing the processes for switching between the beam paths during the pulse pauses as far as possible.

If the target positions of the individual beam paths are arranged in a correspondingly linear pattern it is possible to irradiate a laser line on the processing plane by sequentially switching the pulsed or continuous wave (CW) laser beam through all the beam paths in sequence and controlling the relative speed between the processing head and the processing plane appropriately.

In general, the option exists not to switch the full power of a laser beam to a single beam path, but to divide that power among several beam paths at the same time. With the suggested device, the total number of possible target positions—that is to say the end positions of the individual beam paths in the processing plane—is greater than the maximum number of positions that can be irradiated at the same time, referred to in the following text as processing positions.

In the preferred variant of the suggested device, the laser beam source assembly comprises multiple laser beam sources, which generate multiple separate laser beams. A dedicated optical switching device which is capable of switching each of the laser beams to multiple spatially separated paths is then assigned to each of these laser beams. In this context, the option exist to configure the optical switching devices in such manner that each laser beam is able to use all available beam guides or beam paths. Another possibility is to assign different beam paths to each laser beam, via which the laser beam may be directed onto the processing plane. In this case, adjacent beam paths of different laser beams preferably share common target positions. It is also possible to realize a combination of the options described above.

The variations explained in the preceding text, in which multiple laser beam sources with respectively assigned optical switching devices are used, enable better utilization of the laser beam sources by switching between the individual beam paths, and also—depending on the geometry to be irradiated—a reduction of the number of times the processing head must pass over the processing plane. This is achieved in that the radiation which is not needed for a given area can be directed to other component regions by the optical switching devices, which could otherwise only be achieved with a further pass.

Correspondingly, in the suggested method a particulate material for the component is melted in layers in a processing plane by irradiation with laser radiation. In this process, the laser beams for irradiation of the material are guided over the processing plane and switched between the beam paths in such manner that one layer of the material is melted each time corresponding to the desired component geometry, and use of the laser power generated by the laser beam sources is optimised by the switching.

The relative movement may be effected in the same way as was described in the document WO 2015/003804 A1 cited earlier.

With the suggested device, the use of a larger number of laser beam sources enabled by the simple scalability of building rate and installation space dimensions results in increased productivity. At the same time, the suggested device also makes it possible to achieve these advantages with the smallest possible number of single beam sources. These beam sources are also operated in the suggested device with practically no interruptions. Accordingly, operation of the device delivers maximum efficiency—defined by the ratio between the laser power used for the melting operation and the total installed laser power. The device and method may be used for any powder-bed based beam fusion method. The use of such a device in industrial manufacturing environments in particular has significant potential. The device enables the additive manufacturing of components with maximized value creation. This results in a substantial increase in productivity of the corresponding manufacturing apparatus and therewith also significant financial advantages, which strongly favour the implementation of powder-bed based beam fusion method in the context of industrial serial production.

### BRIEF DESCRIPTION OF THE DRAWING

In the following section, the suggested device and the suggested method will be explained again in greater detail with reference to exemplary embodiments thereof in conjunction with the drawing. In the drawing:

FIG. 1 is a diagrammatic representation of the process chain in selective laser melting;

FIG. 2 is a highly simplified comparison in diagram form between the irradiation unit of a device according to the related art and the irradiation unit of a variant of the suggested device;

FIG. 3 is a diagrammatic representation of a variant of the suggested device;

FIG. 4 is a comparison between the irradiation process in a device according to the related art and in a variant of the suggested device; and

FIG. 5 is a diagrammatic representation of a further variant of the suggested device.

### WAYS TO REALISE THE INVENTION

In powder-bed based beam fusion methods such as selective laser melting, the value-adding irradiation process is interrupted by processes that do not add value such as layer application, process preparation and follow-up processing. This process chain is represented diagrammatically in FIG. 1, which shows the process preparation 12, layer application 13, irradiation 14 and follow-up processing 15 processes in the defined sequence. The layer application 13 and irradiation 14 processes are repeated one layer at a time until the three-dimensional component is fully constructed. The suggested method and the associated device enable the irradiation process to be optimised.

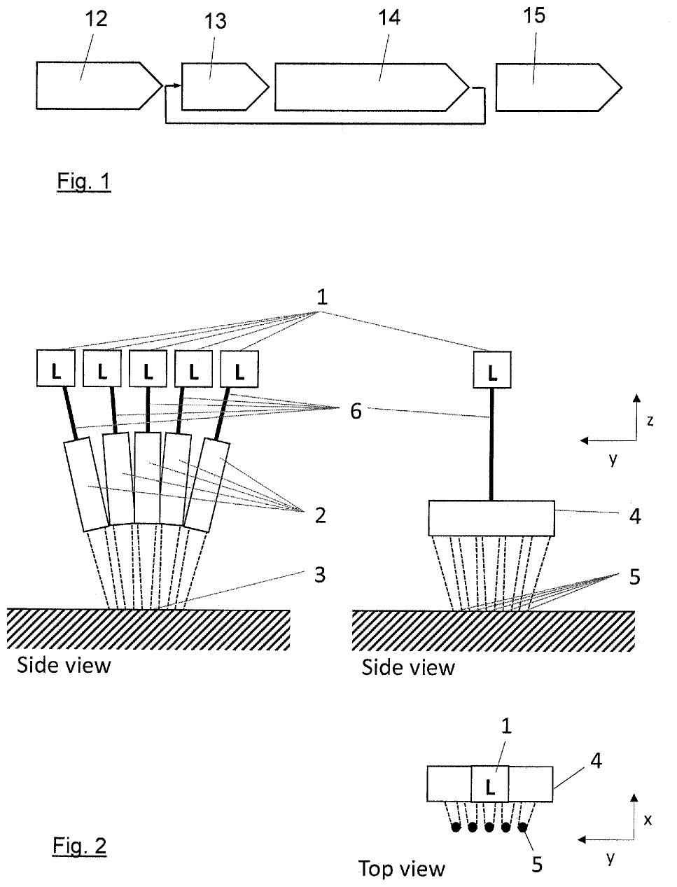

With the suggested device, the capacity utilization of the laser beam sources can be increased compared with a device according to the related art, as is described in WO 2015/003804 A1, for example. With this device of the related art, a plurality of laser beam sources 1 connected to a processing head via optical fibres 6 are used. The processing head has a beam guide with focusing optics 2 for each laser beam source 1, via which guide the respective laser beam is directed to a target position in the processing plane 8 on a defined beam path. This enables an arrangement of laser spots 3 to be generated in the processing plane 8, of which the number of spots is equal to the number of installed laser beam sources. This is represented diagrammatically in the left part of FIG. 2.

In comparison with this, the right part of FIG. 2 in the upper panel shows a device according to the present invention, for which in this example only one laser beam source 1 is used, and is connected to an optical switching device 4 via an optical fibre 6 or other light conducting device, by which switching device the laser beam can be steered onto any one or more beam paths and consequently any one or more target positions 5 in the processing plane 8. The separate beam guides with focusing optics needed here as well are not represented in the figure. The lower panel of the figure shows a top view of this arrangement. Therefore, only one laser beam source 1 whose beam can be switched as necessary to the various beam paths by means of the optical switching device 4 is needed for the diagrammatically represented five beam paths.

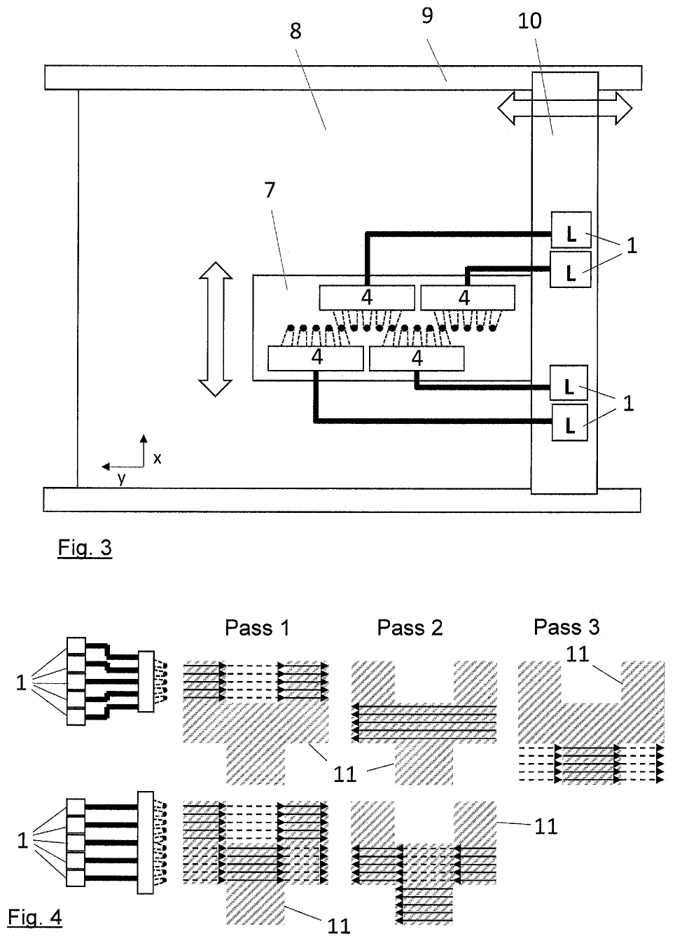

For simultaneous irradiation of multiple target positions, multiple laser beam sources 1 and multiple optical switching devices 4 are used in the suggested device, as is shown for exemplary purposes in FIG. 3. In such cases, one of the optical switching devices 4 is assigned to each laser beam source 1 and laser beam and is table to switch the laser beam according to multiple beam paths and target positions. The optical switching devices 4 are each integrated in the processing head 7. The laser beam sources 1 may also be integrated in the processing head 7, or they may also be arranged outside the processing head 7 and connected to the processing head 7 via optical fibres for example.

In the example of FIG. 3, four optical switching devices 4 are located inside the processing head 7, each being connected to a beam source 1. The processing head 7 is fixed on a linear axis 10, which itself is mounted on two linear axes 9 aligned perpendicularly thereto. Of course, it is also possible for only one drive axis to be provided in conjunction with an additional guide therefor. In this way, the processing head 7 can be moved over the entire processing plane 8. The beam sources 1 in this example are arranged on the linear axis 10. They may also be arranged at other points.

The optical elements 4 are arranged in such manner that at one, but preferably multiple target positions of the respectively adjacent optical elements 4 may be irradiated with one optical element. These target positions are represented in FIG. 3 as laser spots 3 in the processing plane. The individual target positions are preferably located in a row, as is indicated schematically in the figure. In this way, a laser line may be created in the processing plane, for example. In order to construct a component, the processing head 7 is moved over the processing plane along a serpentine traverse for example, and the optical switching devices 4 are activated during this process in such manner that the respective target positions located within the current irradiation field of the processing head 7 that form part of the component geometry to be generated are irradiated.

A further exemplary embodiment is represented in Figure in comparison with the use of a device according to the related art, such as that of WO 2015/003804 A1. In this figure, the upper part shows the irradiation process with the device according to the related art, the lower part illustrates the irradiation process with the suggested device. For this comparison, it is assumed that both devices have the same number of laser beam sources 1, although the suggested device reaches a larger number of adjacent target positions or laser spots, and thus also a greater irradiation width due to its switching capabilities. Figure shows that with the suggested device the component geometry 11 of a layer represented may be irradiated with fewer passes of the processing head than with the device according to the related art. In the example shown, this is possible due to the fact that radiation which is not needed during a single pass can be directed to other component regions by the optical switching devices, wherein these regions can only be reached with a second pass using a device according to the related art. The solid arrows in the figure represent paths that are irradiated, the dashed arrows represent paths that are not irradiated. The comparison in FIG. 4 also shows that the laser beam sources activated are utilized better in the suggested device, since in this example they are operated practically without interruption for melting the component layer. Of course, the greater effectiveness of the suggested device compared with the device of the related art also depends on the component geometry to be created.

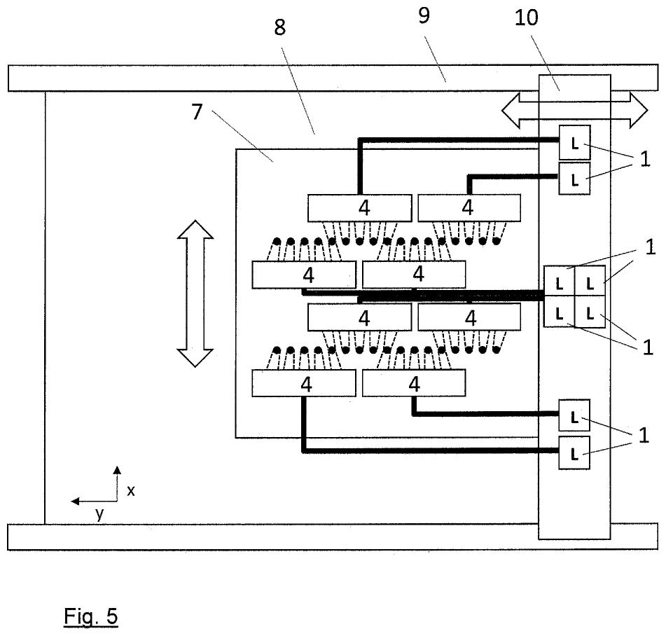

The suggested device may also be designed such that the target positions are arranged not in one row but in several rows one behind the other. An example of this expansion of the field of the target positions in a second dimension as well is discernible in FIG. 5. Here, a second row of target positions is generated by additional optical switching devices 4 and associated laser beam sources 1. The beam sources 1 in this example are also arranged on the linear axis 10. They may also be arranged at other points. Of course, the suggested device is also not limited to the target position arrangements shown. These may be arranged differently.

The number of target positions per optical switching device and the number of optical switching devices per processing head depend not only on the technological limits, particularly with regard to the dimensions and load-bearing capabilities of the components of the optical switching device, but to a large extent on the spot size, the dimensions of the available installation space, and the desired plant productivity. An essential design criterion is that it should be possible to activate the beam sources used practically without interruption in average operating circumstances, so that the highest possible fraction of installed laser power can be transformed into melted component volume in the irradiation process.

The device can be utilized particularly advantageously when a pulsed or modulated process management is used instead of a continuous wave (CW) mode. The optical switching device requires a certain switching time in order to switch the laser beam to a different beam path and thus steer it from one target position to the next. If this switching time is in a favourable ratio to the duty cycle used, i.e. pulse duration and pulse pause, when the relative speed between the processing head and the processing plane is adjusted to the component geometry an entire spot line may be irradiated using substantially fewer beam sources than there are spot and target positions.

The target positions may also be arranged in such manner that the laser spots overlap in the processing plane. The processing head is preferably designed with the optical switching devices in such manner that each target position may be irradiated from multiple laser beam sources. In this context, a component layer is irradiated in such manner that during a pass by the processing head the individual optical switching devices may be controlled in such manner that all component regions located within the field of the available target positions are irradiated, while the associated beam sources emit radiation with as little interruption as possible for melting the component layer. In the suggested device, the level of the power emitted may be varied preferably by means of a control device depending on the component geometry and the switching position of the associated optical switching device.

### LIST OF REFERENCE NUMBERS

1 Laser beam source
2 Focusing optics
3 Laser spot
4 Optical switching device
5 Target position
6 Optical fibre
7 Processing head
8 Processing plane
9 Linear axes
10 Linear axis
11 Component geometry
12 Process preparation
13 Layer application
14 Irradiation
15 Follow-up processing

1. Device for additive manufacturing of components, in particular for selective laser melting or laser sintering, having
a processing head which has a plurality of spatially separated beam guides, via which one or more laser beams can be directed onto a processing plane along spatially separated beam paths,
a laser beam source assembly for generating the one or more laser beams,
a device for supplying a material in the processing plane,
a moving device, with which a relative movement between processing head and processing plane can be effected, and
a control device, with which the moving device can be activated to effect the relative movement,
wherein one or more optical switching devices are present, with which the beam path of the one or more laser beams can be switched between the spatially separate beam paths.

2. Device according to claim 1,
characterized in that
the laser beam source assembly comprises multiple laser beam sources for generating multiple laser beams, wherein a dedicated optical switching device is provided for each laser beam.

3. Device according to claim 2,
characterized in that
each beam path ends at a target position in the processing plane, wherein at least some of the target positions of the beam paths are different for different laser beams.

4. Device according to claim 3,
characterized in that
adjacent beam paths of different laser beams have common target positions.

5. Device according to claim 1,
characterized in that
the control device is designed such that it activates the one or more optical switching devices in such manner that the laser power generated by the laser beam sources is utilized to the greatest degree possible for each component geometry that is to be irradiated.

6. Device according to claim 1,
characterized in that
the number of spatially separated beam paths is greater than the number of laser beam sources by a factor of at least 2.

7. Device according to claim 1,
characterized in that
the processing head comprises multiple focusing optics, by means of which the laser beams can be focused in the direction of the processing plane.

8. Device according to claim 1,
characterized in that
the optical switching devices are formed by electro-optical elements.

9. Device according to claim 1,
characterized in that
the moving device has one axis of translation or two axes of translation perpendicular to each other, by means of which the processing head is movable in a plane parallel to the processing plane.

10. Method for additive manufacturing of components with a device according to claim 1, in which a particulate material for the component is melted in layers in a processing plane by irradiation with laser radiation from one or more laser beam sources, wherein in order to irradiate the material the laser beams are guided over the processing plane, and switching is carried out between the beam paths in such manner that one layer of the material in each case is melted according to the desired component geometry, and the laser power generated by the laser beam sources is utilized to the maximum degree possible.
